(19) United States
(12) Patent Application Publication
(10) Pub. No.: US 2002/0077838 A1
(43) Pub. Date: Jun. 20, 2002

(54) Sound muffler device for use with a portable phone and method and system in electronic commerce for reservation and lease of the sound muffler device

(75) Inventor: Rabindranath Dutta, Austin, TX (US)

Correspondence Address: Joseph R. Burwell, Law Office of Joseph R. Burwell, P. O. Box 28022, Austin, TX, 78755-8022, US

(73) Assignee: INTERNATIONAL BUSINESS MACHINES CORPORATION, ARMONK, NY (US)

(21) Appl. No.: 09/740,529

(22) Filed: Dec. 18, 2000

(51) Int. Cl. G06F 17/60

(52) U.S. Cl. 705/1

(57) ABSTRACT

A sound muffling device, cup, or mask, fits over a portion of a user's face and surrounds the user's mouth. The user speaks into the sound muffling device, which also includes some method for directing the user's speech into a portable phone. A user's conversation on a portable phone can remain confidential and does not disturb nearby persons. Conversely, the conversation is isolated from the interference of nearby noise. Other features, such as reserving or leasing the use of the sound muffling device, is also described.

### BACKGROUND OF THE INVENTION

1. Field of the Invention

The present invention is directed to a sound muffling device for masking speech from a person into a cell phone and for masking ambient sound from being received by the cell phone. In addition, the present invention includes a method and system for automated electrical business practice for an electronic transaction for reserving a sound muffling device using a reservation system.

2. Description of Related Art

The number of portable phones, i.e. cell phones, in use continues to increase rapidly. As the usage of cell phones grows, the sound emitted by speakers talking into cell phones is becoming a common annoyance and inconvenience in many situations. This is particularly a problem in enclosed public places with people in close proximity, such as passenger cabins within airplanes and trains.

As a related problem, when someone is using a cell phone, external sound can be picked up by the cell phone and can interfere with the conversation. The person using the phone can try to cup a hand over the microphone, but this action may or may not limit the external sound depending on the design of the cell phone.

As another problem, people often try to keep their phone conversations private and confidential. Since a cell phone is carried so that the user can receive calls at any time, many calls may be received in public places, which obviously creates difficulties in preventing others from hearing a private conversation.

Therefore, it would be advantageous to provide a device for allowing a user to maintain privacy of a cell phone conversation while also reducing the annoyance created by a cell phone conversation on nearby persons. Because such a device might be particularly useful in certain social situations, such as airplane cabins, a method and system is also proposed for allowing a service provider to reserve and lease such a device to interested persons.

### SUMMARY OF THE INVENTION

A sound muffling device to be used in conjunction with a portable phone is presented. The sound muffling device has a body having a substantially closed end and a substantially open end, although the substantially closed end has at least one relatively small opening, whereas the substantially open end has a relatively large opening of a size and contour such that the substantially open end is adapted to be placed over a mouth of a user while engaging a face of the user to form an effective sound seal around the mouth.

In a first embodiment, the sound muffling device has a sound wave guidance tube. The sound wave guidance tube has a first end connected to the substantially closed end of the body such that the opening in the first end and an opening in the substantially closed end of the body are substantially matched. The passage between the openings allows sound waves to pass from the body into the sound wave guidance tube. The second end of the sound wave guidance tube has an adapter for attaching or coupling to an exterior case of a portable phone in close proximity to a microphone on the portable phone.

In a second embodiment, a microphone is attached to the body, and the microphone generates an output electrical signal responsive to sound waves from a voice of the user. An electrical conductor carries the generated output signal from the microphone to an adapter that couples to an electrical contact on a portable phone such that the microphone acts as an exterior microphone for the portable phone.

Other features, methods, systems, and useful features are described within the detailed description of the invention.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a prior art device for muffling sound;

FIGS. 1B-1D depict a typical cell phone device;

FIG. 2A is a diagram depicting a sound muffling device for directing sound waves from a user to a cell phone microphone in a confidential and quiet manner;

FIG. 2B is a diagram depicting a sound muffling device for capturing speech with a microphone within the sound muffling device and transmitting an electrical signal from the sound muffling device to an electrical contact on the cell phone in accordance with a preferred embodiment of the present invention;

FIG. 3 depicts a typical distributed data processing system in which the present invention may be implemented; and

FIG. 4 is a simple block diagram showing a user system and a reservation system for conducting an online transaction for reserving a sound muffling device for a cell phone.

### DETAILED DESCRIPTION OF THE INVENTION

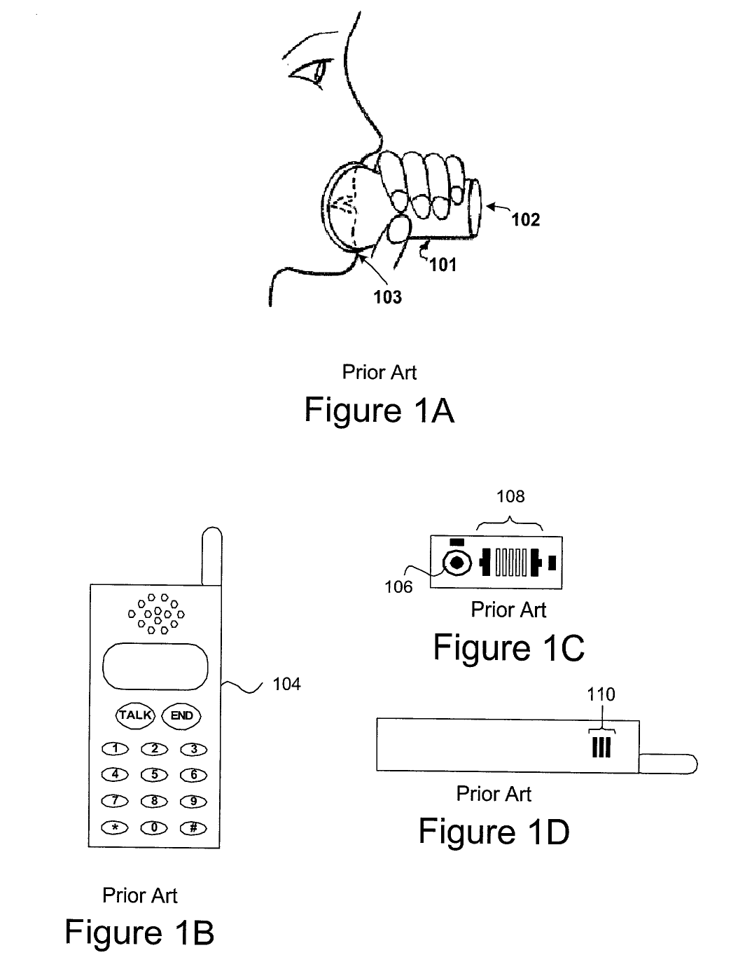

With reference now to FIG. 1A, a prior art device for muffling sound is depicted. The present invention uses a sound muffler similar to the device shown in FIG. 1A. A substantially hollow body, such as sound muffling cup or mask 102, has a substantially closed end 102 and an open end shaped to straddle the mouth and to engage the face of a person. Preferably, the open end of the muffler is surrounded with a relatively compliant foam or similar material 103 to conform to the shape of the face and improve the sealing of the device to the face of a user. The compliant foam material can be selected to lessen the sound of the user's speech by absorbing sound waves while also creating a comfortable, close seal with the face. The combination of the compliant material with the saddle-shaped opening forms an effective seal around the user's face surrounding the user's mouth, thereby creating an efficient sound deadening device.

The sound muffler device may be held in contact with the face by holding the device with the hand and pressing the device against the face. Alternatively, the device may be equipped with a strap that attaches on two sides of the device and circles the head, thereby holding the device in place. Preferably, the strap is made of a stretching or flexible material so that the tightness of the device against the face can be controlled by the user. As another alternative, the device is merely held in place by some other means, such as using the ears for support by hooking a frame behind the ears in a manner similar to eyeglasses. It should be noted that the present invention is not affected by the manner in which the device forms a seal with the user's face.

With reference now to FIGS. 1B-1D, a typical cell phone device is depicted. Referring to FIG. 1B, cell phone 104 includes a small display, speaker, and keys for operating the cell phone, which may be an analog cellular phone, a digital mobile phone, or some other type of handheld phone. Referring to FIG. 1C, a view of the bottom of the cell phone is provided. Contact 106 accepts a plug from an electrical adapter for recharging the cell phone, and electrical contacts 108 provide a connection for an external microphone and speaker, which are commonly available. Referring to FIG. 1D, a small opening 110 in the case of the cell phone is shown for accepting sound waves from the exterior of the cell phone case for the interior microphone. Obviously, the type and location of the various contacts and electrical features may vary depending upon the type of cell phone. For example, on some cell phones, a microphone would be clearly visible below the keys of the phone.

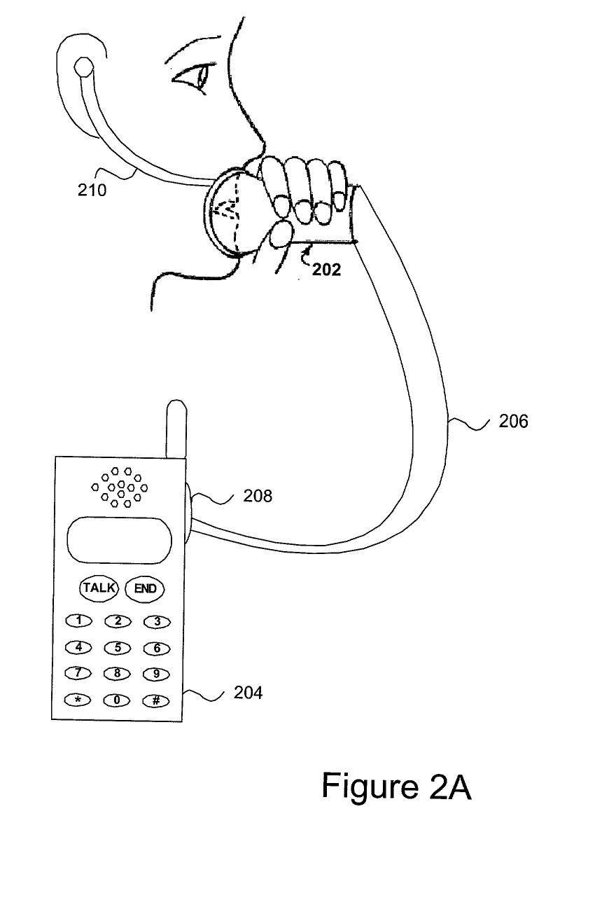

With reference to FIG. 2A, a diagram depicts a sound muffling device for directing sound waves from a user to a cell phone microphone in a confidential and quiet manner. A user is shown holding sound muffling device 202 to the user's face, although a soundproof seal may be formed in other ways, as noted above. In this embodiment, the substantially closed end of sound muffling device 202 has a small opening to which one end of sound wave guidance tube 206 is attached. The other end of sound wave guidance tube 206 attaches to cell phone 204 at coupler 208, which is preferably located adjacent to or in close proximity to the microphone of the cell phone.

Coupler 208 may be constructed in a variety of manners. Preferably, coupler 208 attaches to the exterior cell phone case or housing and has a small opening that substantially matches the opening in the cell phone case for receiving sound waves for the cell phone's microphone. Coupler 208 should conform to the shape of the cell phone case to improve the sealing of the device to the cell phone. A compliant foam material can be selected which substantially surrounds the opening of coupler 208 to lessen the leakage of sound from the sound wave guidance tube and to absorb exterior sound waves. Alternatively, coupler 208 includes a suction cup for attaching the sound wave guidance tube to the cell phone housing in close proximity to the cell phone microphone.

As the user speaks into the sound muffling device, some of the sound waves from the user's speech are carried from the sound muffling device through the sound wave guidance tube to the microphone of the cell phone. Cell phone microphones are generally configured to be sensitive to sound, so the amount of sound that needs to be channeled to the cell phone may be relatively small. Other persons are not able to hear the user's speech, thereby decreasing any annoyance created by the user's conversation. The user may employ the main cell phone speaker to listen to the conversation or may employ a standard headset earpiece.

Because a cell phone has only one speaker, the user generally holds the cell phone up to one ear. In order to improve the quality of sound that the user receives and to minimize the distractions of exterior sounds or ambient noise, the user may to cover their other ear the other hand. This problem is also alleviated with an embodiment of the present invention that comprises both a mouth muffler and an ear muffler. In addition to the sound muffling function provided by the sound muffling mask or cup of the present invention, the sound muffler device may have an attached ear muffler or ear cover 210 which covers the “free” or “unused” ear during the conversation on the cell phone. The ear cover may be made of a compliant foam material to improve the sound wave isolation properties of the ear cover.

With reference to FIG. 2B, a diagram depicts a sound muffling device for capturing speech with a microphone within the sound muffling device and transmitting an electrical signal from the sound muffling device to an electrical contact on the cell phone in accordance with a preferred embodiment of the present invention. FIG. 2B is similar to FIG. 2A, and similar reference numerals refer to similar elements.

In this embodiment of the present invention, sound muffler device 202 is connected to cell phone 204 by electrical connector 212. Sound muffler 202 has microphone 214 for converting sound impulses to electrical signals at the substantially closed end of the sound muffler device, although the location of the microphone may be configured in various locations on or within the sound muffler device. Electrical connection 212 carries electrical signals from the sound muffler's microphone to the cell phone and attaches to the cell phone at electrical contact 216. The cell phone accepts the transmitted signals as originating from an external microphone.

As the user speaks into the sound muffling device, the user's speech is converted into electrical signals for transmission by the cell phone to one or more other parties to the conversation. Other nearby persons are not inconvenienced by the conversation, and exterior noise is not picked up by the cell phone. The user may also use an ear cover 210 in this embodiment of the invention.

While the sound muffling device of the present invention is useful in many situations, it may be more useful in some situations than in other situations. For example, the sound muffling device would be particularly useful in enclosed places with many people, especially in places in which social convention promotes an expectation that persons should limit the amount of conversation. Hence, the sound muffling device would be particularly useful within airplane and train cabins.

In order to promote a pleasant atmosphere within a cabin of a transport vehicle, the operator of the vehicle may provide the sound muffling device for its passengers. Not only are some people less inconvenienced by one or more noisy conversations, someone who uses the device can conveniently engage in a private conversation that the person might not otherwise complete in such social situations. Many business travelers may also use their time productively on the phone without disturbing surrounding persons. While some transport operators may freely loan such devices to passengers, other operators may desire to lease or loan such devices in order to cover the cost of providing the devices, etc.

As background for a distributed system that may be used to engage in the reservation or leasing of such devices, a typical organization of hardware and software components within a distributed data processing system is described prior to describing the present invention in more detail.

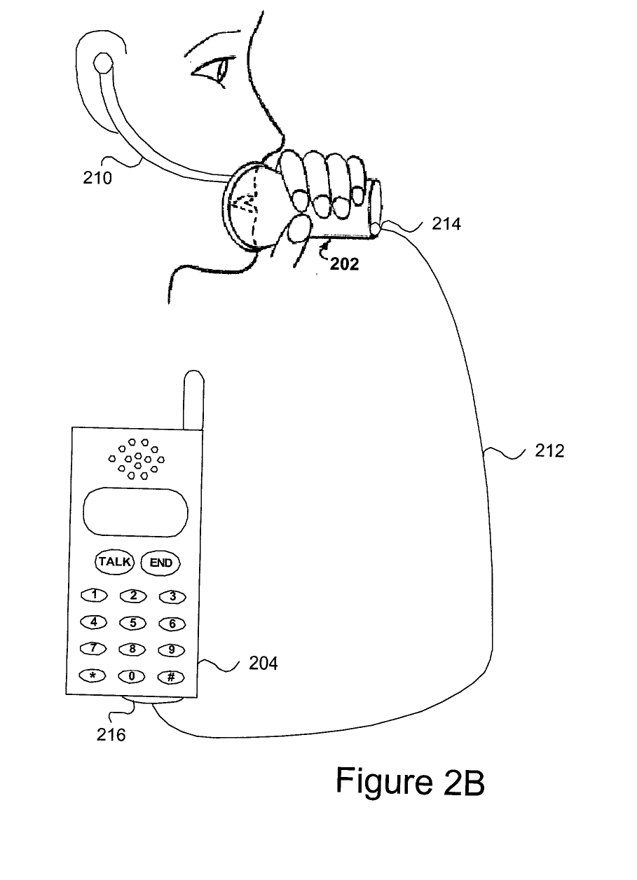

With reference now to the figures, FIG. 3 depicts a typical network of data processing systems, each of which may implement the present invention. Distributed data processing system 300 contains network 301, which is a medium that may be used to provide communications links between various devices and computers connected together within distributed data processing system 300. Network 301 may include permanent connections, such as wire or fiber optic cables, or temporary connections made through telephone or wireless communications. In the depicted example, server 302 and server 303 are connected to network 301 along with storage unit 304. In addition, clients 305-307 also are connected to network 301. Clients 305-307 and servers 302-303 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 300 may include the Internet with network 301 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 300 may also include a number of different types of networks, such as, for example, an intranet, a local area network (LAN), or a wide area network (WAN). For example, server 302 directly supports client 309 and network 310, which incorporates wireless communication links. Network-enabled phone 311 connects to network 310 through wireless link 312, and PDA 313 connects to network 310 through wireless link 314. Phone 311 and PDA 313 can also directly transfer data between themselves across wireless link 315 using an appropriate technology, such as Bluetooth™ wireless technology, to create so-called personal area networks (PAN) or personal ad-hoc networks. In a similar manner, PDA 313 can transfer data to PDA 317 via wireless communication link 316.

The present invention could be implemented on a variety of hardware platforms; FIG. 3 is intended as an example of a heterogeneous computing environment and not as an architectural limitation for the present invention.

In addition to being able to be implemented on a variety of hardware platforms, the present invention may be implemented in a variety of software environments. A typical operating system may be used to control program execution within each data processing system. For example, one device may run a Unix ® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 3 is contemplated as being fully able to support a variety of peer-to-peer subnets and peer-to-peer services.

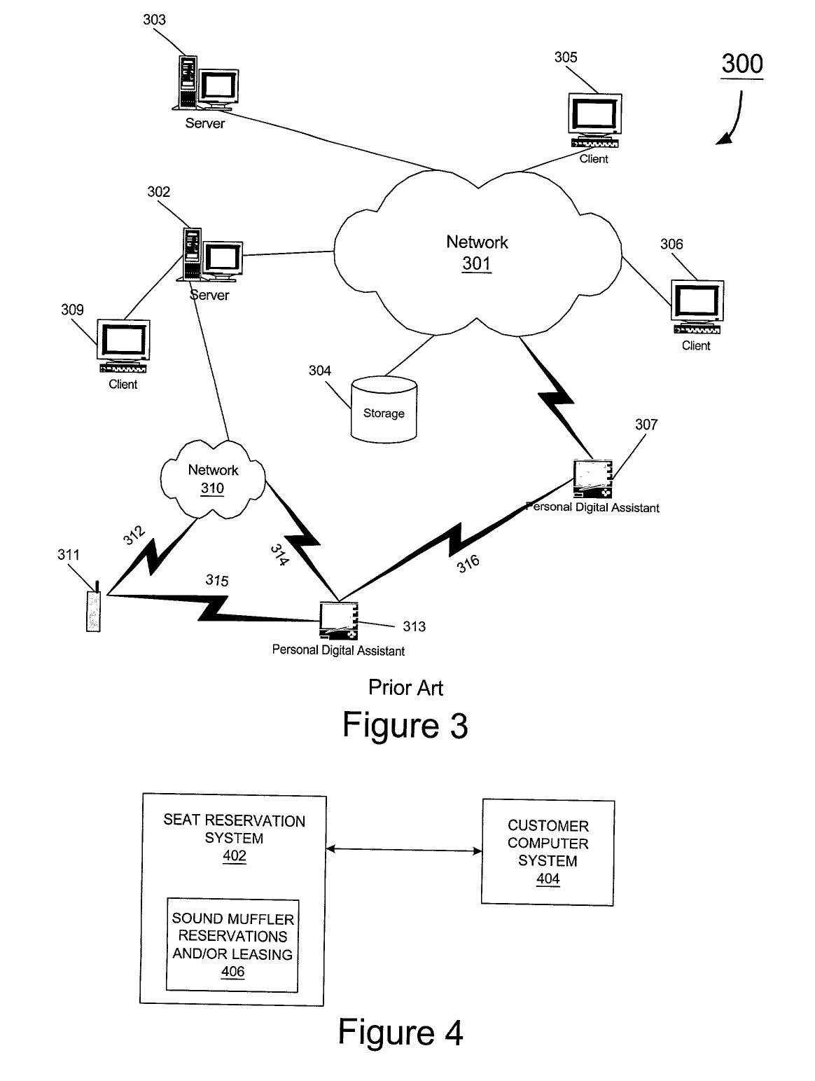

With reference now to FIG. 4, a simple block diagram shows a user system and a reservation system for conducting an online transaction for reserving a sound muffling device for a cell phone. A transport operator processes reservations for seats on a vehicle using seat reservation system 402 in a manner which is commonly known. A user can interact with seat reservation system 402 using a client machine, i.e., customer computer system 404, which is also commonly known. Reservation may be transmitted as online transactions between computers. Additionally, some reservations may be made in-person or over the phone in conjunction with use of the reservation system. It is assumed that seat reservation system 402 is connected to any appropriate online financial services in order to complete an electronic transaction.

However, as noted above, a transport operator may desire to provide the sound muffling devices described above with respect to FIGS. 2A-2B. On the other hand, the transport operator may not have sufficient supplies of the devices and may need to reserve the devices using some type of priority system, such as first-class only or first-come, first-serve. Alternatively or additionally, the transport operator may desire to lease the devices as a revenue source while also providing convenience to passengers who believe that they need the device for privacy or other reasons. Hence, seat reservation system 402 may also include functionality 406 for reserving and/or leasing sound muffling devices.

It is important to note that while the present invention for reserving sound muffling devices has been described in the context of a fully functioning data processing system, those of ordinary skill in the art will appreciate that the reservation processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A sound muffling device comprising:
a body having a substantially closed end and a substantially open end, wherein the substantially closed end has at least one opening, and wherein the substantially open end has a size and contour such that the substantially open end is adapted to be placed over a mouth of a user while engaging a face of the user to form an effective sound seal around the mouth;
a sound wave guidance tube, wherein the sound wave guidance tube has a first end connected to the substantially closed end of the body, and wherein an opening of the sound wave guidance tube and an opening in the substantially closed end of the body are substantially matched to allow sound waves to pass from the body into the sound wave guidance tube; and
an adapter for connecting a second end of the sound wave guidance tube to an exterior case of a portable phone in close proximity to a microphone on the portable phone.

2. The device of claim 1 further comprising:
an ear cover attached to the body, wherein the ear cover extends to substantially cover an ear of the user in order to muffle sound entering the ear.

3. The device of claim 1 wherein the adapter comprises a suction cup for attaching the second end of the sound wave guidance tube.

4. A sound muffling device comprising:
a body having a substantially closed end and a substantially open end, wherein the substantially closed end has at least one opening, and wherein the substantially open end has a size and contour such that the substantially open end is adapted to be placed over a mouth of a user while engaging a face of the user to form an effective sound seal around the mouth;
a microphone attached to the body, wherein the microphone generates an output electrical signal responsive to sound waves from a voice of the user;
an electrical conductor for carrying the generated output signal from the microphone; and
an adapter for connecting the electrical conductor to an electrical contact on a portable phone such that the microphone acts as an exterior microphone for the portable phone.

5. The device of claim 4 further comprising:
an ear cover attached to the body, wherein the ear cover extends to substantially cover an ear of the user in order to muffle sound entering the ear.

6. A method for using a distributed data processing system, the method comprising:
receiving a seat reservation for a passenger on a transport vehicle;
determining whether to reserve a sound muffling device for the passenger, wherein the sound muffling device is adapted to couple to a portable phone; and
in response to a positive determination to reserve a sound muffling device for the passenger, reserving a sound muffling device for the passenger.

7. The method of claim 6 wherein the sound muffling device has a body having a substantially closed end and a substantially open end, wherein the substantially closed end has at least one opening, and wherein the substantially open end has a size and contour such that the substantially open end is adapted to be placed over a mouth of a user while engaging a face of the user to form an effective sound seal around the mouth.

8. The method of claim 6 further comprising:
charging the passenger a fee for use of the sound muffling device.

9. A system for using a distributed data processing system, the system comprising:
receiving means for receiving a seat reservation for a passenger on a transport vehicle;
determining means for determining whether to reserve a sound muffling device for the passenger, wherein the sound muffling device is adapted to couple to a portable phone; and
reserving means for reserving, in response to a positive determination to reserve a sound muffling device for the passenger, a sound muffling device for the passenger.

10. The system of claim 9 wherein the sound muffling device has a body having a substantially closed end and a substantially open end, wherein the substantially closed end has at least one opening, and wherein the substantially open end has a size and contour such that the substantially open end is adapted to be placed over a mouth of a user while engaging a face of the user to form an effective sound seal around the mouth.

11. The system of claim 9 further comprising:
charging means for charging the passenger a fee for use of the sound muffling device.

12. A computer program product in a computer readable medium for use in a data processing system, the computer program product comprising:
instructions for receiving a seat reservation for a passenger on a transport vehicle;
instructions for determining whether to reserve a sound muffling device for the passenger, wherein the sound muffling device is adapted to couple to a portable phone; and
instructions for reserving, in response to a positive determination to reserve a sound muffling device for the passenger, a sound muffling device for the passenger.

13. The computer program product of claim 12 wherein the sound muffling device has a body having a substantially closed end and a substantially open end, wherein the substantially closed end has at least one opening, and wherein the substantially open end has a size and contour such that the substantially open end is adapted to be placed over a mouth of a user while engaging a face of the user to form an effective sound seal around the mouth.

14. The computer program product of claim 12 further comprising:
instructions for charging the passenger a fee for use of the sound muffling device.
